(19) United States
(12) Patent Application Publication
(10) Pub. No.: US 2025/0245899 A1
(43) Pub. Date: Jul. 31, 2025

(54) MOTION GENERATION SYSTEMS AND METHODS

(71) Applicants: NAVER CORPORATION, Gyeonggi-do (KR); NAVER LABS CORPORATION, Gyeonggi-do (KR)

(72) Inventors: Nicolas UGRINOVIC, Barcelona (ES); Thomas LUCAS, Grenoble (FR); Fabien BARADEL, Meylan (FR); Philippe WEINZAEPFEL, Montbonnot-Saint-Martin (FR); Francesc MORENO-NOGUER, sant Cugat del Valles (ES); Gregory ROGEZ, Gières (FR)

(73) Assignees: NAVER CORPORATION, Gyeonggi-do (KR); NAVER LABS CORPORATION, Gyeonggi-do (KR)

(21) Appl. No.: 18/423,893

(22) Filed: Jan. 26, 2024

(51) Int. Cl. G06T 13/40; G06T 7/70; G06V 10/774; G06V 10/776; G06V 40/20

(52) U.S. Cl. CPC G06T 13/40; G06T 7/70; G06V 10/774; G06V 10/776; G06V 40/20; G06T 2207/10016; G06T 2207/20081; G06T 2207/30196

(57) ABSTRACT

A motion generation system includes: a model configured to generate a rendering of a human performing an action in a space, the model including: an encoder module configured to encode input into encodings; a prediction module configured to generate predicted trajectories of the human performing the action based on the encodings using a latent space; a decoder module configured to generate decodings based on the predicted trajectories; and a rendering module configured to generate the rendering based on the decodings; and a training module configured to: (a) train the model based on input video including humans performing actions; and (b), after (a), train the model based on geometry of a scene, one or more target actions for performance by a human in the scene, and observations of the human during performance of the one or more target actions in the scene.

### FIELD

The present disclosure relates to image processing systems and methods and more particularly to systems and methods for generating sequences of predicted three dimensional (3D) human motion.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Images (digital images) from cameras are used in many different ways. For example, objects can be identified in images, and a navigating vehicle can travel while avoiding the objects. Images can be matched with other images, for example, to identify a human captured within an image. There are many more other possible uses for images taken using cameras.

A mobile device may include one or more cameras. For example, a mobile device may include a camera with a field of view covering an area where a user would be present when viewing a display (e.g., a touchscreen display) of the mobile device. This camera may be referred to as a front facing (or front) camera. The front facing camera may be used to capture images in the same direction as the display is displaying information. A mobile device may also include a camera with a field of view facing the opposite direction as the camera referenced above. This camera may be referred to as a rear facing (or rear) camera. Some mobile devices include multiple front facing cameras and/or multiple rear facing cameras.

### SUMMARY

In a feature, a motion generation system includes: a model configured to generate a rendering of a human performing an action in a space, the model including: an encoder module configured to encode input into encodings; a prediction module configured to generate predicted trajectories of the human performing the action based on the encodings using a latent space; a decoder module configured to generate decodings based on the predicted trajectories; and a rendering module configured to generate the rendering based on the decodings; and a training module configured to: (a) train the model based on input video including humans performing actions; and (b), after (a), train the model based on geometry of a scene, one or more target actions for performance by a human in the scene, and observations of the human during performance of the one or more target actions in the scene.

In further features, during (a), the training module is configured to train the encoder module and the decoder module based on the input video.

In further features, the encoder module includes a quantizer.

In further features, the training module is configured to train the encoder module based on minimizing a difference between a discrete latent sequence and a latent sequence output by the encoder module.

In further features, the training module is further configured to train the encoder module and the decoder module based on minimizing a difference between an output of the decoder module and a predetermined output.

In further features, the encoder module includes an auto-regressive encoder.

In further features, the encoder module includes the Transformer architecture.

In further features, the training module is configured to train the latent space during (a) based on the input video including humans performing actions.

In further features, the training module is configured to train the encoder module and the decoder module during (b) based on the geometry of the scene, the one or more target actions for performance by the human in the scene, and the observations of the human during performance of the one or more target actions in the scene.

In further features, during (b), the training module is configured to train the encoder module and the decoder module based on the geometry of the scene, the one or more target actions for performance by the human in the scene, and the observations of the human during performance of the one or more target actions in the scene.

In further features, the observations initially include a target position and pose of the human in the scene.

In further features, the training module is configured to train the model based on minimizing a prediction loss during (b).

In further features, the training module is configured to determine the prediction loss based on an output of the encoder and a predetermined output.

In further features, the training module is further configured to train the model based on minimizing a contact loss during (b).

In further features, minimizing the contact loss includes increasing contact between the human and an object in the scene.

In further features, the training module is further configured to train the model based on minimizing an interpenetration loss during (b).

In further features, minimizing the interpenetration loss includes preventing the human from penetrating an object in the scene.

In further features, the encoder module is configured to add time dependent encodings to frames of video.

In further features, the training module is further configured to, during (b) train the model further based on a target path of the human in the scene.

In further features, the training module is further configured to, during (b) train the model further based on one or more future observations of the human during performance of the one or more target actions in the scene.

In a feature, a training method for a model configured to generate renderings of humans includes: (a) training a latent space using video including humans performing actions; and (b), after (a), using the trained latent space, training a model configured to generate a rendering of a human performing an action in a space using based on geometry of a scene, one or more target actions for performance by a human in the scene, and observations of the human during performance of the one or more target actions in the scene.

In a feature, a motion generation system configured to generate a rendering of a human performing a target action in an inference scene includes: a generator module configured to encode input into encodings, the input including the target action to be performed in the inference scene and a geometry of the inference scene; a prediction module configured to generate predicted trajectories of the human performing the target action based on the encodings using a latent space; a decoder configured to generate decodings based on the predicted trajectories; and a rendering module configured to generate the rendering based on the decodings, where the motion generation system is trained based on: (a) input video including humans performing one or more training actions in a training scene; and (b), after training based on (a), based on geometry of the training scene, the one or more training actions for performance by a human in the training scene, and observations of the human during performance of the one or more training actions in the training scene.

In further features, the input to the generator module further including past observations of the human in the inference scene.

In a feature, a motion generation method includes: (a) training a model based on input video including humans performing actions, the model configured to generate a rendering of a human performing an action in a space, the model including: an encoder module configured to encode input into encodings; a prediction module configured to generate predicted trajectories of the human performing the action based on the encodings using a latent space; a decoder configured to generate decodings based on the predicted trajectories; and a rendering module configured to generate the rendering based on the decodings; and (b), after (a), training the model based on geometry of a scene, one or more target actions for performance by a human in the scene, and observations of the human during performance of the one or more target actions in the scene.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure will become more fully understood from the detailed description and the accompanying drawings, wherein:

FIG. 1 is a functional block diagram of an example computing device;

FIG. 2 includes, on the left, an example input sequence of observations and, on the right, an example input sequence of observations and additionally a sequence of three dimensional (3D) renderings of a human performing an action;

FIG. 3 includes a functional block diagram of an example implementation of a rendering module;

FIG. 4 is a functional block diagram of an example implementation illustrating training and operation;

FIG. 5 is a functional block diagram of an example training system;

FIG. 6 includes an example illustration of a rendering of a human in a space performing a target action of sit on the chair;

FIG. 7 includes an example illustration of a rendering of a human in space performing a target action of sit on a couch;

FIG. 8 is another functional block diagram of the example implementation of FIG. 4 illustrating the embedding/encoding and conditioning;

FIG. 9 is an example illustration of conditioning;

FIG. 10 is another functional block diagram of the example implementation of FIG. 4 without future conditioning;

FIG. 11 is a functional block diagram illustrating an example of the training; and

FIG. 12 is a flowchart depicting an example training method.

In the drawings, reference numbers may be reused to identify similar and/or identical elements.

### DETAILED DESCRIPTION

Generating realistic and controllable motion sequences is a complex problem.

The present application involves systems and methods for generating motion sequences involving a learning-based neural network model (hereinafter referred to as a model) for motion generation that can be controlled using various forms of contextual information in order to navigate and interact with scenes (e.g., virtual). Human motion may be determined by several forms of context. Among them are scene geometry, semantics of the surrounding objects, past motion and target actions and poses.

In the model discussed herein, human motion is first mapped into an abstract discrete feature (latent) space, such as without any conditioning. Any human motion given as input can be represented as a trajectory in that discrete latent space, such as a sequence of centroids. After this, motion may be modeled in a probabilistic manner, directly in that latent space, by predicting latent trajectories, such as in an auto-regressive manner. Next, various forms of contextual information can be used to condition the model and reduce prediction uncertainty. The latent trajectory is then mapped back into a continuous motion representation and latent trajectories are finally decoded into motion.

The present application uses various combinations of contextual information, such as scene geometry, past observations, and one or more future targets. Regarding scene geometry, the scene in which the target action(s) are to be performed may be represented as a point cloud, encoded, and used to condition our generative model in latent space to exploit this information. The model may be conditioned on future trajectories and (e.g., randomly) selected future poses. Finally, semantic information is used. To achieve semantic control, the second stage model may be conditioned on target poses which are generated using pairs of actions and object labels as targets as. This offers semantic control over the generated sequence.

By combining this with conditioning on the past, multiple action/object targets can be chained together, which offers even more flexible semantic control and enables generation of longer motion sequences, despite training on short-term sequences. For instance, long sequences with multiple actions at different locations in the scene (e.g., conditioned on an interaction with nearby objects) can be generated while using a conditioning corresponding to locomotion to navigate (e.g., move along a path in the scene from this first object to this second object).

The model leverages unconditional data together with combinations of contextual information and generates motion to populate virtual scenes. The model can i) leverage large amounts of unconditional data, ii) adapt to various contexts, and iii) provide fine control on model outputs.

An auto-encoder of the model may be trained on large-scale unconditional data, and an auto-regressive component may be trained with various combinations of conditioning signals and later fine-tuned. The systems and methods described herein generate high-quality motion to populate virtual scenes.

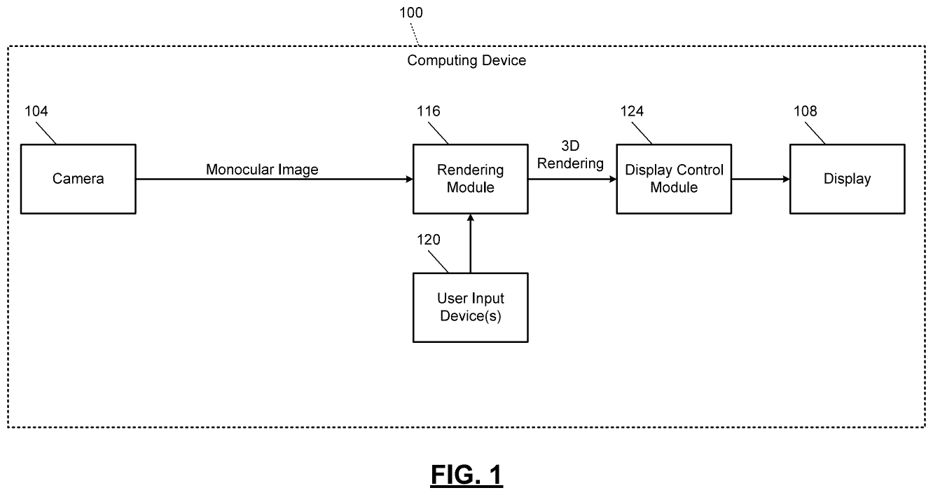

FIG. 1 is a functional block diagram of an example implementation of a computing device 100. The computing device 100 may be, for example, a smartphone, a tablet device, a laptop computer, a desktop computer, or another suitable type of computing device.

A camera 104 is configured to capture images. For some types of computing devices, the camera 104, a display 108, or both may not be included in the computing device 100. The camera 104 may be a front facing camera or a rear facing camera. While only one camera is shown, the computing device 100 may include multiple cameras, such as at least one rear facing camera and at least one forward facing camera. The camera 104 may capture images at a predetermined rate (e.g., corresponding to 60 Hertz (Hz), 120 Hz, etc.), for example, to produce video. The rendering module 116 is discussed further below.

A rendering module 116 generates a sequence of three dimensional (3D) renderings of a human, such as in a virtual space, as discussed further below. The length of the sequence (the number of discrete renderings of a human) and the action performed by the human in the sequence may be set based user input from one or more user input devices 120. Examples of user input devices include but are not limited to keyboards, mouses, track balls, joysticks, and touchscreen displays. In various implementations, the length of the sequence and the action may be stored in memory.

A display control module 124 (e.g., including a display driver) displays the sequence of 3D renderings on the display 108 one at a time or concurrently. The display control module 124 may update what is displayed at the predetermined rate to display video on the display 108. In various implementations, the display 108 may be a touchscreen display or a non-touch screen display.

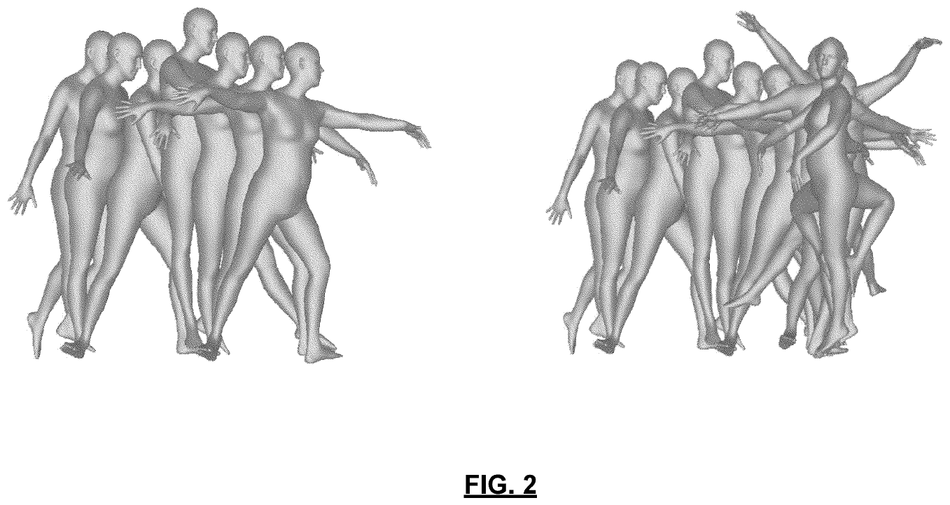

As an example, the left of FIG. 2 includes an example input sequence of observations, such as extracted from images or retrieved from memory. The right of FIG. 2 includes the input sequence of observations and additionally includes a sequence of three dimensional (3D) renderings of a human performing an action.

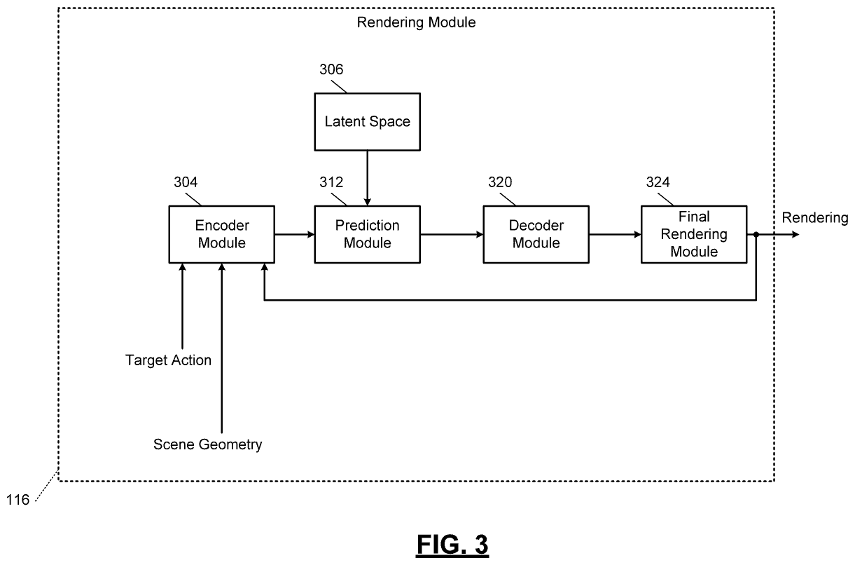

FIG. 3 includes a functional block diagram of an example implementation of the rendering module 116. An encoder module (E) 304 that includes the transformer architecture. Transformer architecture as used herein is described in Ashish Vaswani, Noam Shazeer, Niki Parmar, Jakob Uszkoreit, Llion Jones, Aidan N Gomez, Lukasz Kaiser, and Illia Polosukhin, “Attention is all you need”, In I. Guyon, U. V. Luxburg, S. Bengio, H. Wallach, R. Fergus, S. Vishwanathan, and R. Garnett, editors, Advances in Neural Information Processing Systems 30, pages 5998-6008, Curran Associates, Inc., 2017, which is incorporated herein in its entirety. Additional information regarding the transformer architecture can be found in U.S. Pat. No. 10,452,978, which is incorporated herein in its entirety. The transformer architecture is one way to implement a self-attention mechanism, but the present application is also applicable to the use of other types of attention mechanisms. The encoder module 304 encodes input into representations (e.g., vectors or matrices). In other words, the encoder module 304 maps input to latent space representations 2, respectively. For example, one latent representation (e.g., vector) may be generated for each instantaneous image/pose of the input sequence (latent index sequences). One or more portions of the transformer architecture may be masked.

During training of a latent space 306 used by a prediction module 312 to predict next poses (e.g., via predicted centroid trajectories), videos including human motion are input to the encoder module 304 as discussed further below. During real time operation (model inference), a target action to be performed in a scene, a geometry of the scene, and past observations of the human in the scene are input to the encoder module 304. The prediction module 312 generates a predicted trajectory of the human in the scene at a given time (a latent sequence) based on the representations from the encoder module 304 using the trained latent space 306. The latent sequence is decoded into a sequence of human motion by the decoder module 320.

A final rendering module 324 may visually render the human at the positions and orientations in the sequence and add color to the sequence output by the decoder module 320 and/or texture, such as to make the humans in the sequence more lifelike. The final rendering module 324 may visually render the humans on a display in a virtual space. The final rendering module 324 may also perform one or more other rendering functions. The renderings may be used, for example, by the display control module 124 and displayed on the display 108, for training of a navigating robot, or for another suitable use.

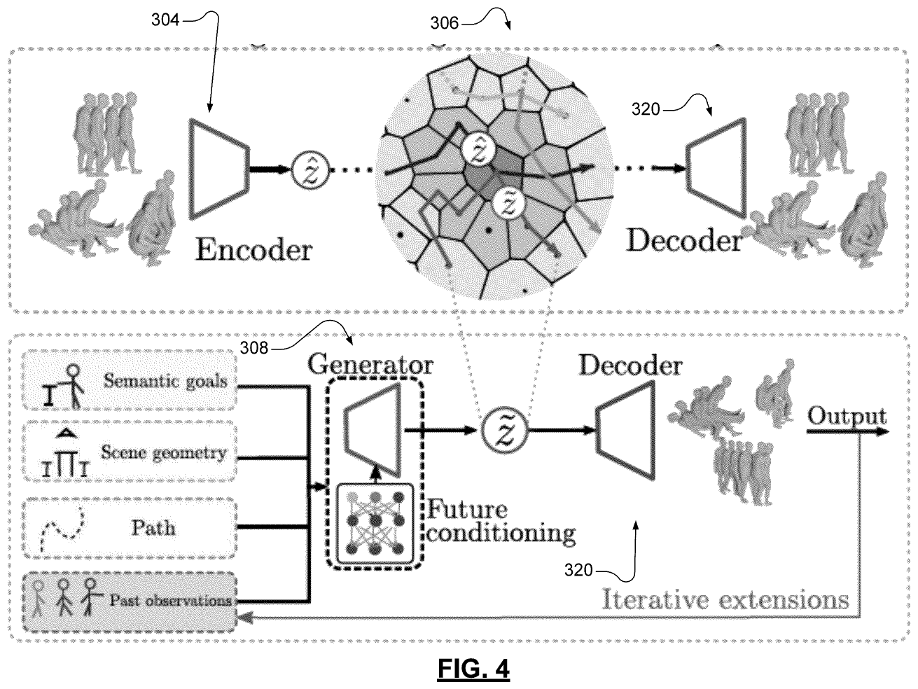

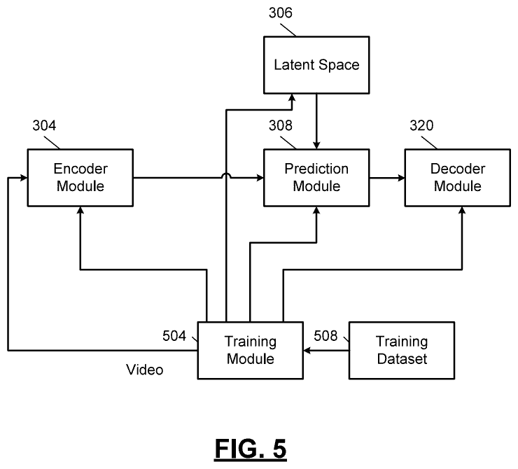

FIG. 4 is a functional block diagram of an example implementation illustrating training and operation. FIG. 5 is a functional block diagram of an example training system.

The top of FIG. 4 illustrates an example first stage. In the first stage, a training module 504 trains/learns the latent space 306. The training module 504 inputs video to the encoder module 304 from a training dataset 508 for the first stage of the training. The video may include, for example, a time series of frames including 3D meshes of keypoints of human bodies moving (e.g., performing actions). The latent space 306 may include a collection of points (e.g., centroid locations). Moving from point to point defines a trajectory in the space. Example points are illustrated by dots in FIG. 4. Arrows connect points and illustrate trajectories over time.

During the first stage, the training module 504 learns the latent space 306 by comparing trajectories predicted by the prediction module 312 based on the input video with predetermined (expected) trajectories, respectively. The training module 504 may learn the latent space 306 based on causing the predicted trajectories to match the predetermined trajectories, respectively.

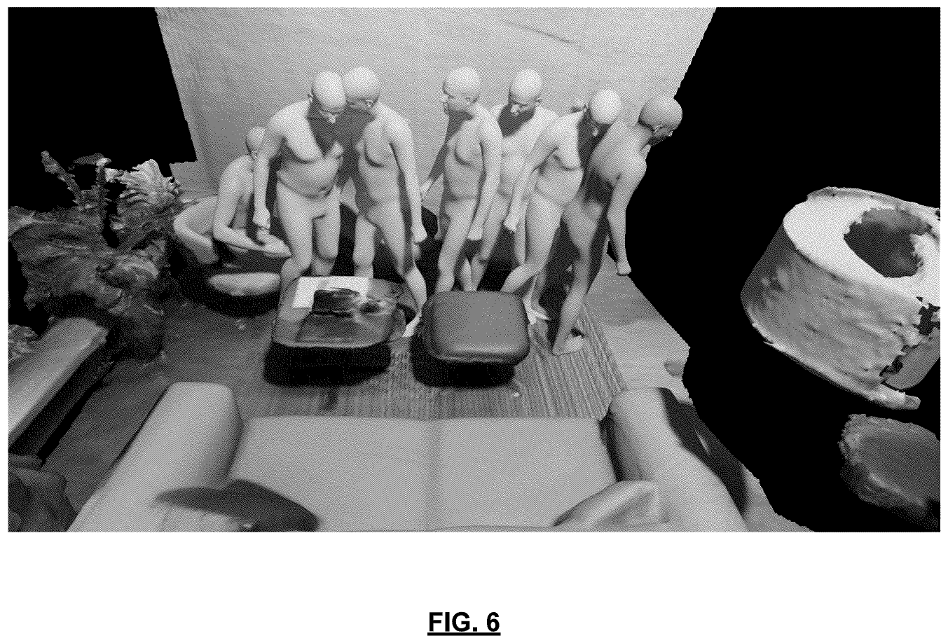

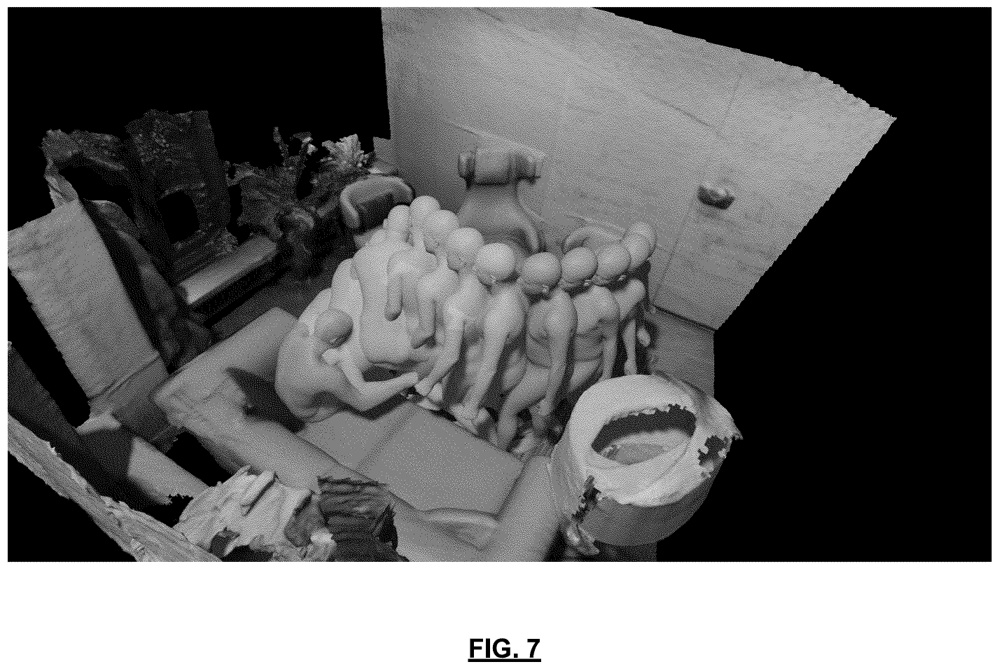

The bottom of FIG. 4 illustrates an example second stage performed after the training of the first stage. In the second stage, the scene geometry, one or more target actions to be performed by the human in the virtual space (illustrated as “Path” in FIG. 4), and one or more past observations are inputs to generator (module) 308. The scene geometry may include, for example, a three dimensional (3D) point cloud representation of the scene in which the one or more target actuations are to be performed. The target actions may be or include semantic goals for performance by the human. For example, FIG. 6 includes an example illustration of a rendering of a human in a space performing a target action of sit on the chair. FIG. 7 includes an example illustration of a rendering of a human in space performing a target action of sit on a couch. While sitting on furniture examples are provided and illustrated, the present application is also applicable to other types of actions.

The past observations may include 3D meshes of humans in past renderings (or observations) during performance of the target action(s). Initially at the start of performing a target action, the past observations may be zero or a starting point and orientation of the human. The past observations may increase in number as the human moves toward accomplishing the target action.

To render a human body in 3D, a parametric differentiable body model B may be used by the final rendering module 324, such as the SMPL-X body model described in Georgios Pavlakos, et al., Expressive Body Capture: 3D Hands, Face, and Body From a Single Image, In CVPR, 2019, which is incorporated herein in its entirety. A D3 human mesh of Nᵥ vertices V∈ [symbol] is obtained based on the parameters of global orientation γ, body pose θ, and translation δ of the root joint through the body model V=B(γ,θ,δ). A human motion sequence p of length T can be described as a concatenation of the parameters, p={p₁, . . . , p_{T}} where pₜ=(γₜ,θₜ,δₜ).

During the first stage of the training, the prediction module 312 learns to compress the motion sequences in the input video into discrete latent representations. To this end, neural discrete representation learning for human motion may be used, such as described in Aaron van den Oord, et a., Neural Discrete Representation Learning, In ICML, 2018, which is incorporated herein in its entirety.

The transformer architecture of the encoder module 304 includes causal attention. The input motions are encoded by the encoder module 304 in a time relative manner and with bounded causal attention. This ensures that the latent space 306 is trained using smaller sequences of length T₁ but can be used to encode longer sequences of length T₂>=T₁.

Regarding the first stage of the training, the training module 504 trains the encoder E(⋅) to map a motion sequence p of length T into a latent sequence of length T_{d}<=T namely E(p)=\hat{z}={\hat{z}₁, . . . , \hat{z}_{T}_{_{d}}} with \hat{z}ᵢ∈ [symbol] . The resulting latent sequence is forced to be temporally consistent by the encoder module 304, for any t<=T_{d},<=\hat{z}ₜ, is a function of {p₁, . . . , p_{└t·T/T}_{_{d}}_{┘}}.

Together with the training of the encoder module 304, the training module 504 trains/learns K latent codebooks {Z₁, . . . , Zₖ} where each codebook includes C centroids, Zₖ={z₁^{k}, . . . , z_{c}^{k}} with zᵢ^{k}= [symbol] . The codebooks are used to learn the best approximate latent variable produced by the encoder module 304 E(⋅) using product quantization. Each element \hat{z}ₜ in a latent space \hat{z} is split into K subvectors \hat{z}_{T}^{k}∈ [symbol] for k=1, . . . , K and the k-th chunk is mapped to its nearest neighbor in Zₖ. The quantization of the whole latent sequence \hat{z} can be written as

$$Q ( \hat{z} ) := {( {arg min}_{z ∈ {Z}_{1} x ... {xZ}_{K}} ‖ {\hat{z}}_{t} - z ‖ )}_{t ∈ \{ 1 , ... , T \}} ∈ {ℝ}^{{T}_{d} \times {N}_{z}} \qquad ( 1 )$$

Motion sequence p is approximately reconstructed from Q(\hat{z}) using the decoder module 320 D(⋅). Reconstruction errors in the motion space and in the latent space can be optimized (e.g., minimized) together by the training module 504, such as by minimizing the equation

$${‖ p - D ( Q ( E ( p ) ) ‖}^{w} + {‖ E ( p ) - Q ( E ( p ) ) ‖}_{2}^{2}$$

Since equation (1) is non-differentiable, the backward pass may be approximated using a gradient approximator. Once the encoder module 304, the decoder module 320, and the codebooks (the latent space 306) are trained and frozen, a motion sequence p from a dataset of human motion V can be represented as a latent trajectory connecting learned centroids, namely a sequence of elements of the codebooks {Z₁, . . . , Z_{K}}. Each set of latent trajectories Z may be denoted

$$Z = {∩}_{T = 1}^{∞} [ {( {Z}_{1} , … , {Z}_{K} )}^{T} ] \qquad ( 2 )$$

$$\hat{V} = Q ( V ) : = \{ z ∈ Z \vert p ∈ V , z = Q ( E ( p ) ) \} \qquad ( 3 )$$

Sequences of arbitrary length in Z can be constructed by chaining together centroids from Z₁, . . . , Zₖ. To allow for longer lengths during the second stage of the training, the self attention mechanisms may be implemented to have time shift consistency, which may be defined as

$$∃ L ∀ t \geq L , ∀ {δ}_{1} \geq 0 , ∀ {δ}_{2} \geq 0 , {p}^{1} , {p}^{2} : {p}_{{δ}_{1}}^{1} , … , {p}_{{δ}_{1 + t}}^{1} = {p}_{{δ}_{2}}^{2} , \text{} … , {p}_{{δ}_{2 + t}}^{2} ⟹ ( D ∘ Q ∘ E ) {( {p}^{1} )}_{⌊ {δ}_{1} + \frac{t}{2} ⌋} = ( D ∘ Q ∘ E ) {( {p}^{2} )}_{⌊ {δ}_{2} + \frac{t}{2} ⌋} \qquad ( 4 )$$

To achieve this, relative time embeddings and causal attention are used by the decoder module 320. In self-attention, intermediate D-dimensional representations are mapped using three feature-wise linear projections into query Q∈ [symbol] , the key K∈ [symbol] , and value V∈ [symbol] . A bounded causal mask with attention span Tₑ is defined as

$${C}_{i , j}^{b o u n d} = - ∞ \cdot ( 〚 i > j 〛 + 〚 j - i > {T}_{e} 〛 ) + 1 \qquad ( 5 )$$

where [symbol] ⋅ [symbol] denotes the Iverson bracket, such that [symbol] a [symbol] is equal to 1 if a is true and 0 otherwise. The mask restricts the temporal window of the self attention used in the first stage. R is denoted as the relative positional encoding. Given the query Q and the key K, positional information is injected by the encoder module 304 such that (R(Q,t₁), R(Q,t₂))=R(QK^{T}, t₂−t₁) so pairwise attention scores depend (e.g., only) on the relative time difference between features instead of absolute time. The self-attention may be expressed as:

$$Attn ( Q , K , V ) = softmax ( \frac{R ( Q ) {R ( K )}^{T} \cdot {C}^{b o u n d}}{\sqrt{{D}_{k}}} ) V ∈ {ℝ}^{N x {D}_{v}} \qquad ( 6 )$$

Generated motion sequences can be conditioned using some context c∈C, i.e., p˜M*(⋅|c) where c is a representation containing information about the scene, semantics, and observations of past motion, and M*(⋅) is a data generating distribution. Assume a prior distribution C(⋅) over C and let V={(pᵢ,cᵢ)|cᵢ˜C,pᵢ˜M*(⋅|cᵢ)} be a dataset of condition motion sequences of size I. The conditioned sequences can be represented in the latent space Z 306 as

$${\hat{V}}_{c} = {\{ ( {Z}_{i} , {c}_{i} ) \vert {z}_{i} = Q ( E ( {p}_{i} ) ) \}}_{i ∈ I} ⊂ Z \times C \qquad ( 7 )$$

Trajectories zᵢ are modeled probabilistically using an auto-regressive model G(⋅) of the prediction module 312 conditioned on available context for zᵢ, such as based on maximizing

$${p}_{G} ( {z}_{i} \vert {c}_{i} ) = {\prod }_{t = 1}^{T} p ( {z}_{i , t} \vert {z}_{i , 1} , … , {z}_{i , t - 1} , c ) \qquad ( 8 )$$

To obtain motion samples, latent sequences are sampled by the prediction module 312 from p_{G} and decided by the decoder module 320 using the decoder D(⋅) as described above.

The scene may be represented as a point cloud, such as S={sᵢ=1, . . . , Nₛ} where sᵢ includes 3D coordinates and a semantic class channel sᵢ=(xᵢ,yᵢ,zᵢ,lᵢ). The point clouds are processed, such as using a deep architecture to learn a set function P. The deep architecture may be, for example, as described in Charles Ruizhongtai Qi, et al., Pointnet: Deep Learning on Point Sets for 3D Classification and Segmentation, CVPR, 2017, which is incorporated herein in its entirety. The set functions may be invariant to permutation of their inputs, and may be computed using the relationship

$$P ( {s}_{1} , … , {s}_{{N}_{S}} ) = F ( H ( {s}_{1} ) , … , H ( {s}_{{N}_{S}} ) ) \qquad ( 9 )$$

with F(⋅) a symmetric function and H(⋅) a featurewise function. The output of the function P is projected with a learnable linear layer Wₛ, such as

$${c}_{s} = {W}_{s} \cdot P ( {s}_{1} , … , {s}_{{N}_{S}} ) \qquad ( 10 )$$

where cₛ is a vector including scene information to condition p_{G}.

When past motion p₁, . . . , pₜ of a length is observed as context/input, it can be encoded by the encoder module 304 into Z. A future human motion of length T can be sampled from the model conditioned on the observation

$${p}_{G} ( z \vert {z}_{1} , … , {z}_{t} ) = {\prod }_{l = t}^{T = t} p ( {z}_{l} \vert {z}_{1} , … , {z}_{l - 1} ) \qquad ( 11 )$$

The autoregressive nature of p_{G} has the flexibility to be conditioned on past motion without requiring further embeddings/encodings or conditioning. p_{G} can also be conditioned on target poses, such as obtained from observations or generated as follows.

The model can be conditioned on semantic information such as (a) multiple action labels and a target interaction between a human and an object in the rendering. The action labels may be time dependent multiple action labels, such as sit down and touch the table. The action labels may be denoted a, a single sequence of length T can have multiple action labels at time t and the action label can vary, such as

$$a = ( {a}_{1} , … , {a}_{T} ) ∈ {\{ 0 , 1 \}}^{{N}_{a} x T} \qquad ( 12 )$$

Action labels are embedded and projected by the encoding module 304 into cₐ and p_{G} is conditioned on the result. Using the time dependent encodings is important and enable more fine grained semantic control of the final renderings of humans.

The prediction module 312 may generate predictions based on pairs of time dependent actions and objects (aₜ,oₜ), such as (lie, couch). In this regard, the task may be divided into two parts: (i) generating a static pose p^{a,o} based on (a,o) denoted p^{a,o}˜p^{a,o}(⋅|(a, o)) and (ii) generating the final target pose based on the result, cₐₒ=Wₐₒ·p^{a,o} where Wₐₒ is a linear layer. A motion that performs actions a with object o is sampled as:

$$z ∼ {p}_{G} ( z \vert {c}_{a o , T} ) with {p}_{T}^{a , o} ( \cdot \vert ( {a}_{T} , {o}_{T} ) \qquad ( 13 )$$

and the latent sequence is decoded into a human motion with the decoder module 320 D(⋅). The training module 504 may perform the second stage of the training based on final target poses in the training dataset 508 instead of generated final target poses. Equation (8) can be re-written based on the types of conditioning described above as:

$${p}_{G} ( {z}_{i} \vert {c}_{i} ) = {\prod }_{t = 1}^{T} p ( {z}_{t} \vert {z}_{1} , … , {z}_{t - 1} , {c}_{s} , {c}_{a} , {c}_{ao , T} ) \qquad ( 14 )$$

To render the motion, latent variables are iteratively sampled by the prediction module 312 and added to the conditioning sequence before being decoded by the decoder module 320.

To encourage consistency between the generated motion and the context scene, two geometric constraints may be enforced by the training module 504 between the generated human mesh and the scene point cloud. To compute these losses, generated latent sequences are decoded into sequences of human body meshes. Collisions are penalized by the training module 504 (e.g., increasing loss) using a signed distance field Ψₛ(⋅) which penalizes a mesh for penetrating the scene, and a contact loss between a pre-defined set of vertices Vₛ {vₛ¹, . . . , vₛ^{N}} in the human mesh, and 3D points of the scene S:

$${ℒ}_{s c e n e} = {𝔼}_{M} [ \vert {Ψ}_{s} ( V ) \vert ] + {E}_{v ∈ {V}_{s} , s ∈ S} [ \vert ρ ( v - s ) ] \qquad ( 15 )$$

where p(⋅) is the Geman-McClure error function, to downweight scene vertices that are far away from the human body mesh. These constraints are used in the training rather than minimizing them, such as with an optimization loop. For the training, the training dataset 508 may include, for example, 100,00 frames with annotations (e.g., ground truth labels) or another suitable number of frames. In various implementations, the video may be captured at 30 frames per second or another suitable frame rate. 20 or another number of human subjects may be included, and 12 or another number of scenes may be used for the training. In various implementations, ⅔ of the training dataset 508 may be used for testing and ⅓ may be used for testing or other suitable portions may be used. The scene and/or target pose may be masked by the training module 508 during the training, such as randomly with a predetermined probability, such as 0.5.

The present application may be implemented in PyTorch and use the Adam optimizer with a learning rate of 10\hat{ }5 or another suitable learning rate for both the first and second stages. The encoder module 304 and the decoder module 320 may be frozen during the training of the prediction module 312 including the generator 308. Different data augmentations may be applied to human motion samples during the training, such as randomly varying the framerate of the sequence by a factor ranging from the magnitude of 0.8 to 1.2, random rotations of the vertical axis of the human motion and the associated scene, and randomly sample the starting timesteps of the sequence. These augmentations and variations may help avoid overfitting.

In summary, the training proceeds in two stages (i) an auto-encoder is trained to move from a continuous input space to a discrete latent space and vice-versa, (ii) the auto-regressive model is trained in this discrete space, and can be fed to the decoder for obtaining the output in the target space. During the first stage, the auto-encoder is trained to compress motion sequences into discrete latent representations with neural discrete representation learning. The encoder module 304 with a quantizer with a codebook and the decoder module 320 are trained by the training module 504 such that a reconstruction error is minimized (e.g., based on minimizing the reconstruction error.

A given motion sequence p of length T can be represented by a discrete sequence of indices z of length T′ Q(E(p)) by the encoder module 304 and the quantizer module. A sequence of discrete latent indices can be decoded by the decoder module 320 into a motion sequence. T′ can be used here instead of T as the sequence in pose space p can be downsampled when converting to the latent discrete space z and then upsampled again by using the decoder module 320 D. To allow conditioning on past observations, the encoder module 304 may include a causal encoder such that for any t<=T′, \hat{z}ₜ, is a function of {p₁, . . . , p_{t*T/T′}}.

The encoder module 304 may include the PoseGPT encoder and quantization for better leveraging the discrete space. The PoseGPT encoder is described in Thomas Lucas et al., PoseGPT: Quantization based 3D Human Motion Generation and Forecasting, ECCV, 2022, which is incorporated herein in its entirety. Additional information regarding the PoseGPT encoder can be found in U.S. patent application Ser. No. 17/956,022, which is incorporated herein in its entirety.

The encoder module 304 and quantizer can be trained direction in the frozen discretized latent space. To generate trajectories in the latent space, the prediction module 312 (e.g., an auto-regressive model) can be trained by the training module 504 to predict the next index such as by maximizing

$${p}_{g} ( z ) = p ( {z}_{1} ) = {\prod }_{t = 2}^{{T}^{′}} p ( {z}_{t} \vert {z}_{1} , … , {z}_{t - 1} )$$

To obtain motion samples, latent sequences are sampled from p_{G} and decoded using the decoder module 320.

While conditioning the encoder module 304 with sequence-wide information, e.g., a fixed context across the full sequence (e.g., static scene information), conditioning based on future information (e.g., a target pose or a path) may be difficult. Some types of conditioning are valid for the full sequence, for example, static scene information, a sequence duration T, or a constant action label. In that case, given an input sequence z₁, . . . , z_{T′} embedded into features h₁, . . . , h_{T}′ and some conditioning signal c represented by a feature vector h_{c}, conditioning be performed by prompting, e.g., adding h_{c} as an extra token at the start of the input sequence.

hₚᵣₒₘₚₜ=(h_{c},h₁, . . . ,h_{T′})

Another solution is to inject it into all input tokens, such as

h_{feat}=(h₁⊕h_{c}, . . . ,h_{T′}⊕h_{c})

where the ⊕ operator denotes an operator that combines two features (e.g., vectors), such as concatenation or summation.

Causal masking may also be used, as discussed above. For future conditioning, a neural network with two branches may be used to compute two stacks of features—a causal branch that predicts the next timestep and a non-causal branch that propagates information about the conditioning at all timesteps—and inject the non-causal branch output into the causal branch output. Given an input token sequence z₁, . . . , z_{T′} and a conditioning sequence c₁, . . . , c_{T}′ both are embedded by the encoding module 304 into feature sequences h⁰ and g⁰, respectively.

A stack of L (L being an integer greater than 1) causal layers f_{c}¹, . . . , f_{c}^{L} is used to compute features h¹, . . . , h^{L} such that for any l and any t, hₗ^{t} is a function of z₁, . . . , z_{T′}. A second stack of non causal layers f¹, . . . , f^{L} is used to process g⁰, and for any 1<=t<=T′

$$\{ \begin{matrix}{h}_{t}^{l} = {f}_{c}^{l} ( {h}_{1}^{l - 1} , … , {h}_{t - 1}^{l - 1} ) , \\ {g}_{t}^{l} = {f}^{l} ( {g}_{1}^{l - 1} , … , {g}_{t}^{l - 1} , … , {g}_{T}^{l - 1} ) , \\ {\tilde{h}}_{t}^{l} = {h}_{t}^{l} + {g}_{t}^{l}\end{matrix}$$

hₜ^{L} is a function of z₁, . . . , zₜ₋₁ and can be used by the prediction module 312 to predict zₜ. Any feature hₜ^{L} a function of all conditioning signal and increasingly complex conditioning features can be learned.

The scene point cloud data may be embedded using the PointNet embedding, which is described in Pointnet: Deep Learning on Point Sets for 3D classification and Segmentation, CVPR, 2017, which is incorporated herein in its entirety.

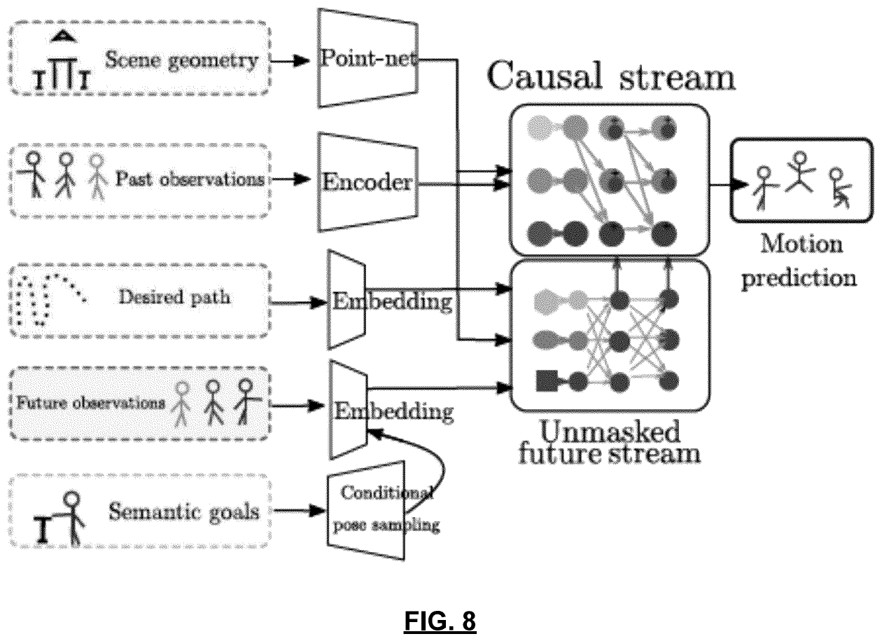

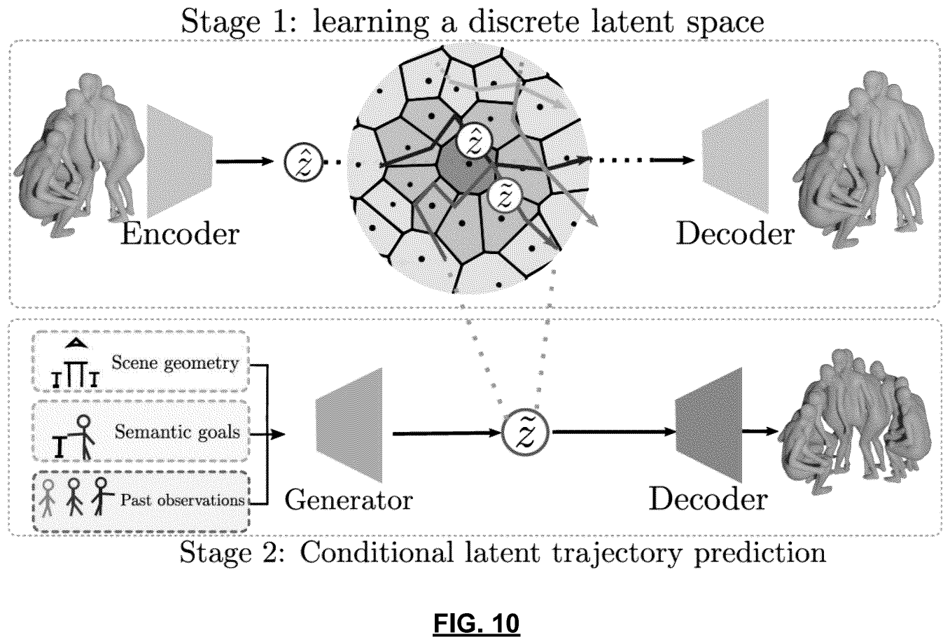

FIG. 8 is another functional block diagram of the example implementation of FIG. 4 illustrating the embedding/encoding and conditioning. FIG. 10 is another functional block diagram of the example implementation of FIG. 4 without the embedding/encoding and conditioning.

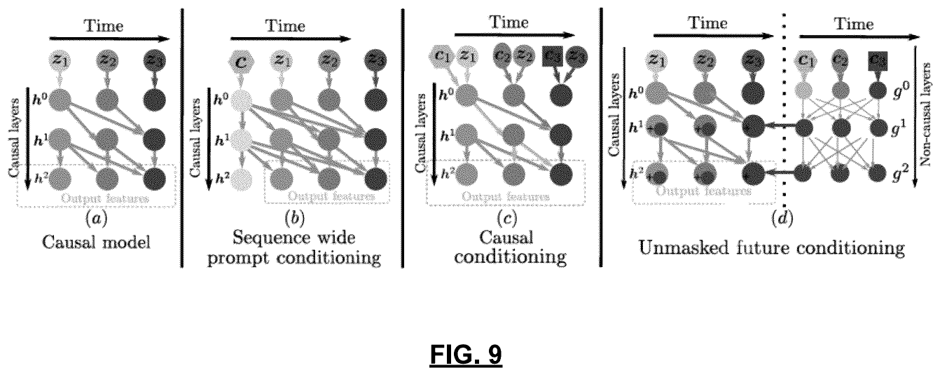

FIG. 9 is an example illustration of conditioning. In (a), an auto-regressive model without conditioning is based on causal attention. In (b), added is a prompt token c₀ to the sequence, and sequence-wide conditioning can be added. In (c), for time-dependent conditioning c₁, . . . , c_{T′} features can be combined, but the model may be unaware of future conditioning when predicting a given timestep. In (d), future conditioning may be applied by applying a non-causal network to process the time-varying conditioning, and combine their future with the causal generative model.

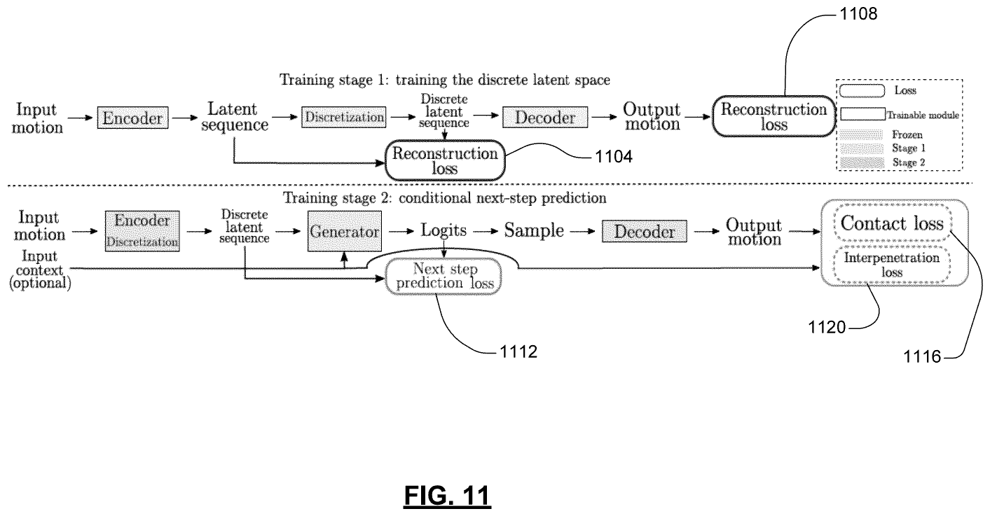

FIG. 11 is a functional block diagram illustrating an example of the training. During the first stage of the training, the training module 504 trains the encoder module 304, the decoder module 320 and the discretization function/module based on minimizing a reconstruction loss 1104, such as described above. Minimizing the reconstruction loss may be based on minimizes differences the latent sequences after discretization and the latent sequences before the discretization, respectively.

The training module 504 also trains the encoder module 304, the decoder module 304, and the discretization based on minimizing reconstruction loss 1108. Minimizing the reconstruction loss 1108 may be based on minimizing differences between the output of the decoder module 320 and expected outputs, respectively.

During the second stage of the training, the training module 504 may train the encoder module, and the generator module 308 based on minimizing a prediction loss 1112. Minimizing the prediction loss may be based on minimizing differences between logits output by the generator module 308 and logits of discrete latent sequences output by the encoder module 304 including the discretization trained after the first stage. The logits may include probabilities for the possible predicted trajectory, respectively. The sampling of FIG. 11 may illustrate selection of the predicted trajectory having the highest probability.

The second stage may also include training the decoder module 320, the encoder module 304, and the generator module 308 based on minimizing a contact loss 1116 and minimizing an interpenetration loss 1120. The logits are used to create the predicted trajectory for the human motion rendering. Minimizing the contact loss 1116 may be based on ensuring that the human contacts the object involved with the target action, such as decreasing the contact loss 1116 when the human actually contacts the object and increasing the contact loss 1116 when the human does not contact the object. Minimizing the interpenetration loss 1120 may be based on ensuring that the human does not penetrate the object in performing the target action, such as decreasing the interpenetration loss 1120 when the human does not penetrate the object and increasing the interpenetration loss 1120 when the human penetrates the object. Training based on the contact loss 1116 and the interpenetration loss 1120 may improve future predictions.

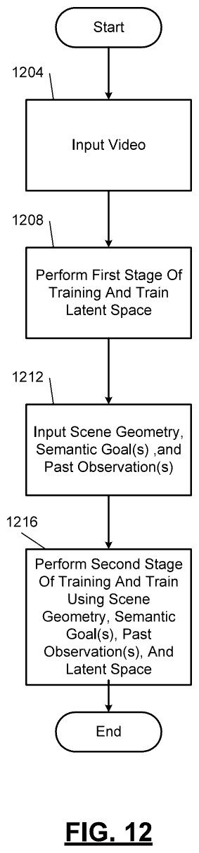

FIG. 12 is a flowchart depicting an example training method. Control begins with 1204 where the training module 504 inputs video of a human performing an action in a space. Over time, multiple videos of multiple humans performing multiple actions may be input.

At 1208, the training module 504 performs the first stage of the training as discussed above and trains the latent space 306 using the input video. The trained/learned latent space 306 is used during the second stage of the training.

At 1212, the training module 504 inputs a scene geometry, one or more target actions, and one or more past observations of a human performing the one or more target actions in the scene. Over time, multiple sets of humans performing multiple actions and sets of observations may be input. At 1216 the training module performs the second stage of the training as discussed above using the trained latent space 306 and trains the model based on the scene geometry, the one or more target actions, and the one or past observations.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment (of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A motion generation system, comprising:
a model configured to generate a rendering of a human performing an action in a space, the model including:
an encoder module configured to encode input into encodings;
a prediction module configured to generate predicted trajectories of the human performing the action based on the encodings using a latent space;
a decoder module configured to generate decodings based on the predicted trajectories; and
a rendering module configured to generate the rendering based on the decodings; and
a training module configured to:
(a) train the model based on input video including humans performing actions; and
(b), after (a), train the model based on geometry of a scene, one or more target actions for performance by a human in the scene, and observations of the human during performance of the one or more target actions in the scene.

2. The motion generation system of claim 1 wherein, during (a), the training module is configured to train the encoder module and the decoder module based on the input video.

3. The motion generation system of claim 2 wherein the encoder module includes a quantizer.

4. The motion generation system of claim 2 wherein the training module is configured to train the encoder module based on minimizing a difference between a discrete latent sequence and a latent sequence output by the encoder module.

5. The motion generation system of claim 4 wherein the training module is further configured to train the encoder module and the decoder module based on minimizing a difference between an output of the decoder module and a predetermined output.

6. The motion generation system of claim 1 wherein the encoder module includes an auto-regressive encoder.

7. The motion generation system of claim 1 wherein the encoder module includes the Transformer architecture.

8. The motion generation system of claim 1 wherein the training module is configured to train the latent space during (a) based on the input video including humans performing actions.

9. The motion generation system of claim 1 wherein the training module is configured to train the encoder module and the decoder module during (b) based on the geometry of the scene, the one or more target actions for performance by the human in the scene, and the observations of the human during performance of the one or more target actions in the scene.

10. The motion generation system of claim 1 wherein, during (b), the training module is configured to train the encoder module and the decoder module based on the geometry of the scene, the one or more target actions for performance by the human in the scene, and the observations of the human during performance of the one or more target actions in the scene.

11. The motion generation system of claim 1 wherein the observations initially include a target position and pose of the human in the scene.

12. The motion generation system of claim 1 wherein the training module is configured to train the model based on minimizing a prediction loss during (b).

13. The motion generation system of claim 12 wherein the training module is configured to determine the prediction loss based on an output of the encoder and a predetermined output.

14. The motion generation system of claim 12 wherein the training module is further configured to train the model based on minimizing a contact loss during (b).

15. The motion generation system of claim 14 wherein minimizing the contact loss includes increasing contact between the human and an object in the scene.

16. The motion generation system of claim 12 wherein the training module is further configured to train the model based on minimizing an interpenetration loss during (b).

17. The motion generation system of claim 16 wherein minimizing the interpenetration loss includes preventing the human from penetrating an object in the scene.

18. The motion generation system of claim 1 wherein the encoder module is configured to add time dependent encodings to frames of video.

19. The motion generation system of claim 1 wherein the training module is further configured to, during (b) train the model further based on a target path of the human in the scene.

20. The motion generation system of claim 1 wherein the training module is further configured to, during (b) train the model further based on one or more future observations of the human during performance of the one or more target actions in the scene.

21. A training method for a model configured to generate renderings of humans, the training method comprising:
(a) training a latent space using video including humans performing actions; and
(b), after (a), using the trained latent space, training a model configured to generate a rendering of a human performing an action in a space using based on geometry of a scene, one or more target actions for performance by a human in the scene, and observations of the human during performance of the one or more target actions in the scene.

22. A motion generation system configured to generate a rendering of a human performing a target action in an inference scene, comprising:
a generator module configured to encode input into encodings, the input including the target action to be performed in the inference scene and a geometry of the inference scene;
a prediction module configured to generate predicted trajectories of the human performing the target action based on the encodings using a latent space;
a decoder configured to generate decodings based on the predicted trajectories; and
a rendering module configured to generate the rendering based on the decodings,
wherein the motion generation system is trained based on:
(a) input video including humans performing one or more training actions in a training scene; and
(b), after training based on (a), based on geometry of the training scene, the one or more training actions for performance by a human in the training scene, and observations of the human during performance of the one or more training actions in the training scene.

23. The motion generation system of claim 22, the input to the generator module further including past observations of the human in the inference scene.

24. A motion generation method, comprising:
(a) training a model based on input video including humans performing actions,
the model configured to generate a rendering of a human performing an action in a space, the model including:
an encoder module configured to encode input into encodings;
a prediction module configured to generate predicted trajectories of the human performing the action based on the encodings using a latent space;
a decoder configured to generate decodings based on the predicted trajectories; and
a rendering module configured to generate the rendering based on the decodings; and
(b), after (a), training the model based on geometry of a scene, one or more target actions for performance by a human in the scene, and observations of the human during performance of the one or more target actions in the scene.
